(19) United States
(12) Patent Application Publication
(10) Pub. No.: US 2025/0210247 A1
(43) Pub. Date: Jun. 26, 2025

(54) SWITCHING POWER SOURCE DEVICE EQUIPPED WITH COMPOSITE POWER INDUCTOR

(71) Applicant: Murata Manufacturing Co., Ltd., Kyoto-fu (JP)

(72) Inventors: Shigeki KOYA, Nagaokakyo-shi (JP); Tatsuya HOSOTANI, Nagaokakyo-shi (JP)

(73) Assignee: Murata Manufacturing Co., Ltd., Kyoto-fu (JP)

(21) Appl. No.: 19/078,483

(22) Filed: Mar. 13, 2025

Related U.S. Application Data
(63) Continuation of application No. PCT/JP2023/036141, filed on Oct. 4, 2023.

(30) Foreign Application Priority Data
Oct. 21, 2022 (JP) 2022-168789

(51) Int. Cl. H01F 27/29; H01F 27/24; H02M 1/44; H02M 3/00

(52) U.S. Cl. CPC H01F 27/29; H01F 27/24; H02M 1/44; H02M 3/003

(57) ABSTRACT

A switching power source device equipped with a composite power inductor includes an inductor conductor having a linear shape, an inductor conductor having a linear shape, an inductor conductor, and a single magnetic body configured to form magnetic paths of magnetic fluxes generated by currents flowing through the inductor conductor, the inductor conductor, and the inductor conductor. One end of the inductor conductor is connected to a first input terminal, and another end of the inductor conductor is connected to one end of the inductor conductor. One end of the inductor conductor is connected to a second input terminal, and another end of the inductor conductor is connected to the one end of the inductor conductor. The inductor conductor, the inductor conductor, and the inductor conductor are interposed by or contained in the magnetic body.

### CROSS-REFERENCE TO RELATED APPLICATIONS

This application claims benefit of priority to International Patent Application No. PCT/JP2023/036141, filed Oct. 4, 2023, and to Japanese Patent Application No. 2022-168789, filed Oct. 21, 2022, the entire contents of each are incorporated herein by reference.

### BACKGROUND

### Technical Field

The present disclosure relates to a switching power source device equipped with a composite power inductor.

### Background Art

A ferrite laminate component including a coil conductor and a magnetic body is described in Japanese Unexamined Patent Application Publication No. 2007-194474. The ferrite laminate component of Japanese Unexamined Patent Application Publication No. 2007-194474 includes an inductor having an intermediate tap and three terminals (a first terminal, a second terminal, and a third terminal).

The first terminal is connected to the intermediate tap of the inductor, the second terminal is connected to one end of the inductor, and the third terminal is connected to another end of the inductor.

### SUMMARY

However, with the configuration described in Japanese Unexamined Patent Application Publication No. 2007-194474, when it is required that an inductor be connected to the intermediate tap in terms of circuitry, it is required that an inductor element other than the ferrite laminate component be included.

For example, when output ripple noises are suppressed in a switching power source device including a plurality of power conversion circuits, it is required that filter circuits be provided at output terminals of the plurality of power conversion circuits. However, for realizing this in the configuration of Japanese Unexamined Patent Application Publication No. 2007-194474, it is required that inductors of the plurality of power conversion circuits and inductors of the filter circuits (output filter circuits) be separately provided. Thus, the number of components included in the switching power source device increases, and a physical size increases.

Accordingly, the present disclosure realizes a composite power inductor for a switching power source device that can realize desired characteristics with a small number of components and in a small physical shape.

A switching power source device equipped with a composite power inductor according to the present disclosure includes a first inductor conductor having a linear shape, a second inductor conductor having a linear shape, a third inductor conductor, and a single magnetic body configured to form magnetic paths of magnetic fluxes generated by currents flowing through the first inductor conductor, the second inductor conductor, and the third inductor conductor. One end of the first inductor conductor is connected to a first input terminal, and another end of the first inductor conductor is connected to one end of the third inductor conductor. One end of the second inductor conductor is connected to a second input terminal, and another end of the second inductor conductor is connected to the one end of the third inductor conductor. The first inductor conductor, the second inductor conductor, and the third inductor conductor are interposed by or contained in the magnetic body. The first inductor conductor and the second inductor conductor are arranged parallel to each other to cause a magnetic flux generated by a current flowing through the first inductor conductor and a magnetic flux generated by a current flowing through the second inductor conductor to cancel out each other in an inner leg portion between the first inductor conductor and the second inductor conductor in the magnetic body and to cause the magnetic flux generated by the current flowing through the first inductor conductor and the magnetic flux generated by the current flowing through the second inductor conductor to strengthen each other in outer leg portions further to outer sides than the first inductor conductor and the second inductor conductor in the magnetic body. The third inductor conductor is disposed such that a plane created by a magnetic flux generated by a current flowing through the third inductor conductor is orthogonal to a plane created by the magnetic flux generated by the current flowing through the first inductor conductor and a plane created by the magnetic flux generated by the current flowing through the second inductor conductor. The first inductor conductor and the second inductor conductor form power conversion circuits. The third inductor conductor forms a low-pass filter for an output current of the power conversion circuits.

According to the present disclosure, the functions to be realized by a plurality of power inductors can be obtained by a single integrated composite power inductor, the magnetic saturation of the magnetic body can be suppressed by cancelling out the magnetic fluxes generated by direct-current output currents, and ripples of an output voltage can be reduced by including a low-pass filter against the output current. The composite power inductor for the switching power source device can be realized with a small number of components and in a physically small shape, and the desired characteristics of the power inductor and the switching power source device such as reduction of the size, an increase in efficiency, and improvement of the performance can be realized.

### BRIEF DESCRIPTION OF THE DRAWINGS

FIG. 1 is an equivalent circuit diagram of a switching power source device equipped with a composite power inductor according to a first embodiment of the present disclosure;

FIGS. 2A and 2B are external perspective views of the composite power inductor according to the first embodiment of the present disclosure;

FIG. 3 is an exploded perspective view of the composite power inductor according to the first embodiment of the present disclosure;

FIG. 4 includes four orthogonal views of the composite power inductor according to the first embodiment of the present disclosure;

FIG. 5 includes four orthogonal views (a plan view, a first end view, a second end view, and a first side view) of a magnetic body obtained by combining a first magnetic body and a second magnetic body and a plan view of the first magnetic body according to the first embodiment of the present disclosure;

FIG. 6 includes four orthogonal views (a plan view, a first end view, a second end view, and a first side view) of a third magnetic body according to the first embodiment of the present disclosure;

FIG. 7 includes four orthogonal views (a plan view, a first end view, a second end view, and a first side view) of a conductor member according to the first embodiment of the present disclosure;

FIGS. 8A, 8B and 8C are diagrams illustrating, in a simplified manner, states of currents and magnetic fields of the composite power inductor according to the first embodiment of the present disclosure;

FIG. 9 is a perspective view illustrating an example of the switching power source device according to the first embodiment of the present disclosure;

FIG. 10 is an exploded perspective view of a composite power inductor according to a second embodiment of the present disclosure;

FIG. 11 is an external perspective view of the composite power inductor according to the second embodiment of the present disclosure;

FIG. 12 is an external perspective view of the composite power inductor according to a third embodiment of the present disclosure;

FIG. 13 is an exploded perspective view of a composite power inductor according to a fourth embodiment of the present disclosure; and

FIG. 14 is an external perspective view of the composite power inductor according to the fourth embodiment of the present disclosure.

### DETAILED DESCRIPTION

### First Embodiment

A composite power inductor and a switching power source device according to a first embodiment of the present disclosure will be described with reference to the drawings.

(A Circuit Configuration of Switching Power Source Device Equipped with Composite Power Inductor)

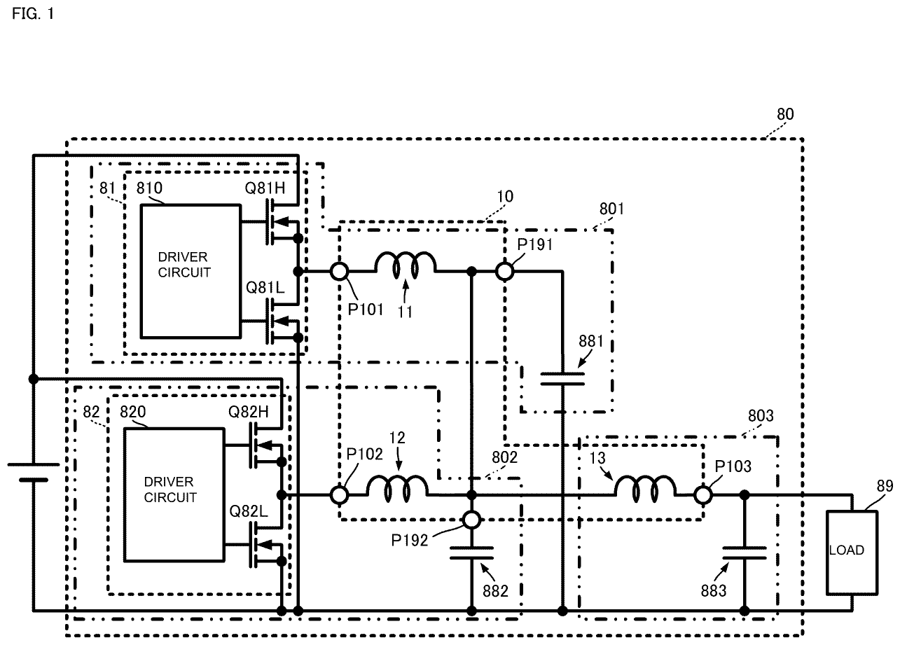

FIG. 1 is an equivalent circuit diagram of a switching power source device equipped with a composite power inductor according to a first embodiment of the present disclosure. As illustrated in FIG. 1, a switching power source device 80 includes a composite power inductor 10, a power semiconductor integrated circuit (IC) 81, a power semiconductor IC 82, a capacitor 881, a capacitor 882, and a capacitor 883.

The power semiconductor IC 81 includes a driver circuit 810, a switching element Q81H, and a switching element Q81L. The power semiconductor IC 82 includes a driver circuit 820, a switching element Q82H, and a switching element Q82L. The switching element Q81H, the switching element Q81L, the switching element Q82H, and the switching element Q82L are power semiconductor elements, for example, power metal oxide semiconductor field-effect transistors (MOSFETs).

The composite power inductor 10 includes an inductor 11, an inductor 12, and an inductor 13. The composite power inductor 10 includes a first input terminal P101, a second input terminal P102, an output terminal P103, a first capacitor terminal P191, and a second capacitor terminal P192.

A DC power source is connected between a Hi-side power source input terminal and a Low-side power source input terminal of the switching power source device 80. The Hi-side power source input terminal is connected to a positive electrode of the DC power source, and the Low-side power source input terminal is connected to a negative electrode of the DC power source.

The driver circuit 810 is connected to a gate terminal of the switching element Q81H and a gate terminal of the switching element Q81L.

A drain terminal of the switching element Q81H is connected to the Hi-side power source input terminal of the switching power source device 80. A source terminal of the switching element Q81H is connected to a drain terminal of the switching element Q81L. A source terminal of the switching element Q81L is connected to the Low-side power source input terminal (terminal connected to a reference potential line) of the switching power source device 80. The reference potential line connects the Low-side power supply input terminal (terminal connected to the negative electrode of the DC power source) of the switching power source device 80 and the Low-side output terminal (terminal connected to a negative electrode of a load 89) of the switching power source device 80 to each other.

A node of the source terminal of the switching element Q81H and the drain terminal of the switching element Q81L is connected to one terminal of the inductor 11 through the first input terminal P101 of the composite power inductor 10.

Another terminal of the inductor 11 is connected to one terminal of the capacitor 881 through the first capacitor terminal P191 of the composite power inductor 10. Another terminal of the capacitor 881 is connected to the reference potential line.

The power semiconductor IC 81 (the driver circuit 810, the switching element Q81H, and the switching element Q81L), the inductor 11, and the capacitor 881 form a first power conversion circuit. Thus, the inductor 11 is an inductor (first inductor) for the first power conversion circuit, and the capacitor 881 is an output capacitor for the first power conversion circuit.

The driver circuit 820 is connected to a gate terminal of the switching element Q82H and a gate terminal of the switching element Q82L.

A drain terminal of the switching element Q82H is connected to the Hi-side power source input terminal of the switching power source device 80. A source terminal of the switching element Q82H is connected to a drain terminal of the switching element Q82L. A source terminal of the switching element Q82L is connected to the Low-side power source input terminal (terminal connected to the reference potential line) of the switching power source device 80.

A node of the source terminal of the switching element Q82H and the drain terminal of the switching element Q82L is connected to one terminal of the inductor 12 through the second input terminal P102 of the composite power inductor 10.

Another terminal of the inductor 12 is connected to one terminal of the capacitor 882 through the second capacitor terminal P192 of the composite power inductor 10. Another terminal of the capacitor 882 is connected to the reference potential line.

The power semiconductor IC 82 (the driver circuit 820, the switching element Q82H, and the switching element Q82L), the inductor 12, and the capacitor 882 form a second power conversion circuit. Thus, the inductor 12 is an inductor (second inductor) for the second power conversion circuit, and the capacitor 882 is an output capacitor for the second power conversion circuit.

The other terminal of the inductor 11 and the other terminal of the inductor 12 are connected to one terminal of the inductor 13. Another terminal of the inductor 13 is connected to the Hi-side output terminal (terminal connected to a positive electrode of the load 89) of the switching power source device 80 through the output terminal P103 of the composite power inductor 10.

The capacitor 883 is connected between the Hi-side output terminal and the Low-side output terminal.

Thus, the inductor 13 and the capacitor 883 forms an output filter circuit of the switching power source device 80. Specifically, the inductor 13 and the capacitor 883 form a low-pass filter for the output current of the power conversion circuits.

With the above-described configuration, the switching power source device 80 includes the first power conversion circuit and the second power conversion circuit, which are connected in parallel, and the output filter circuit connected to the node of the output terminal of the first power conversion circuit and the output terminal of the second power conversion circuit.

Thus, the switching power source device 80 can realize multiple DC/DC converters with the switching elements and suppress output ripple noise.

### (Composite Power Inductor)

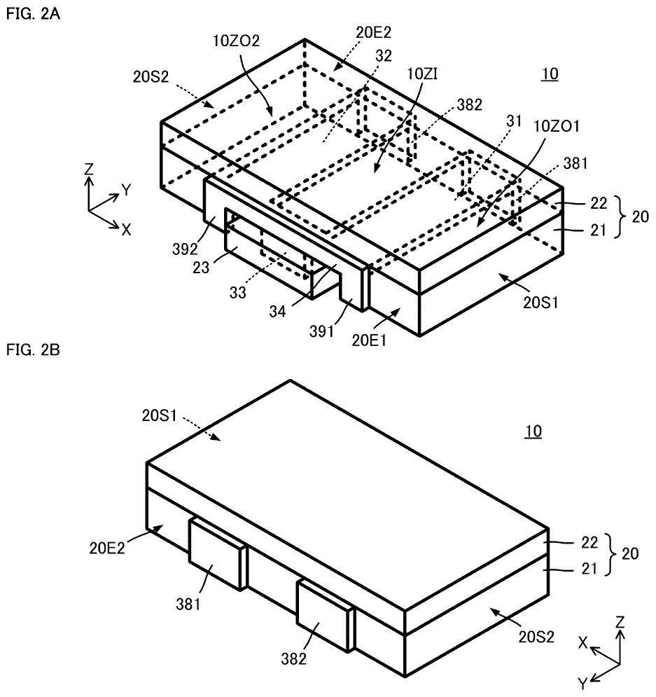

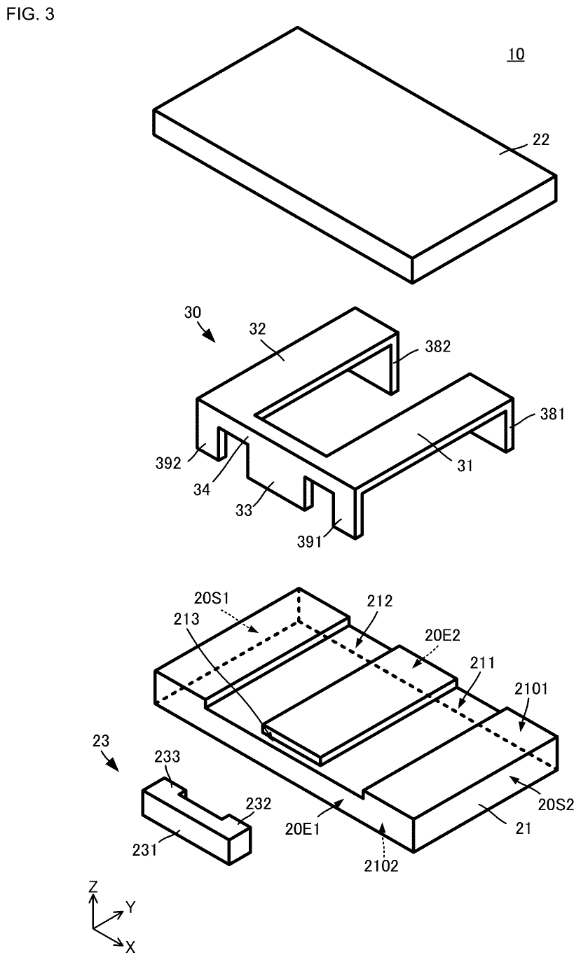

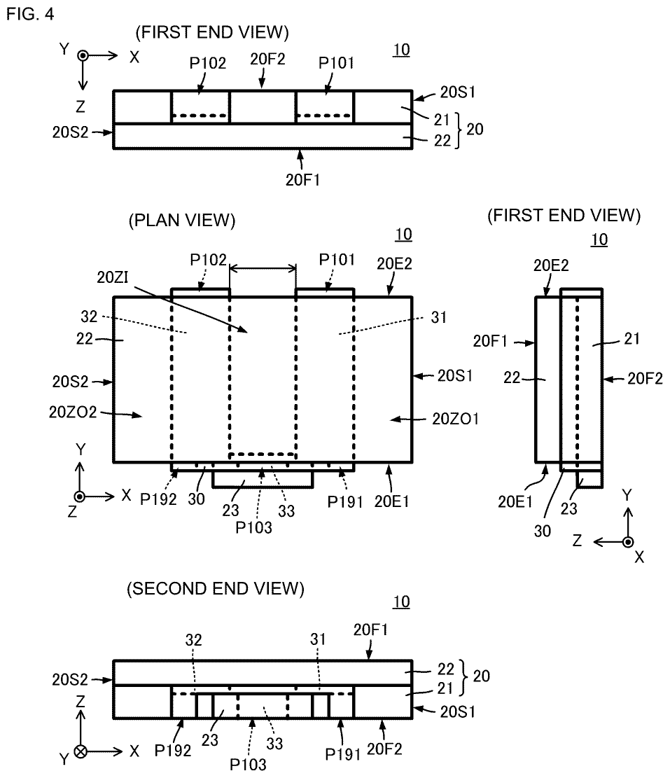

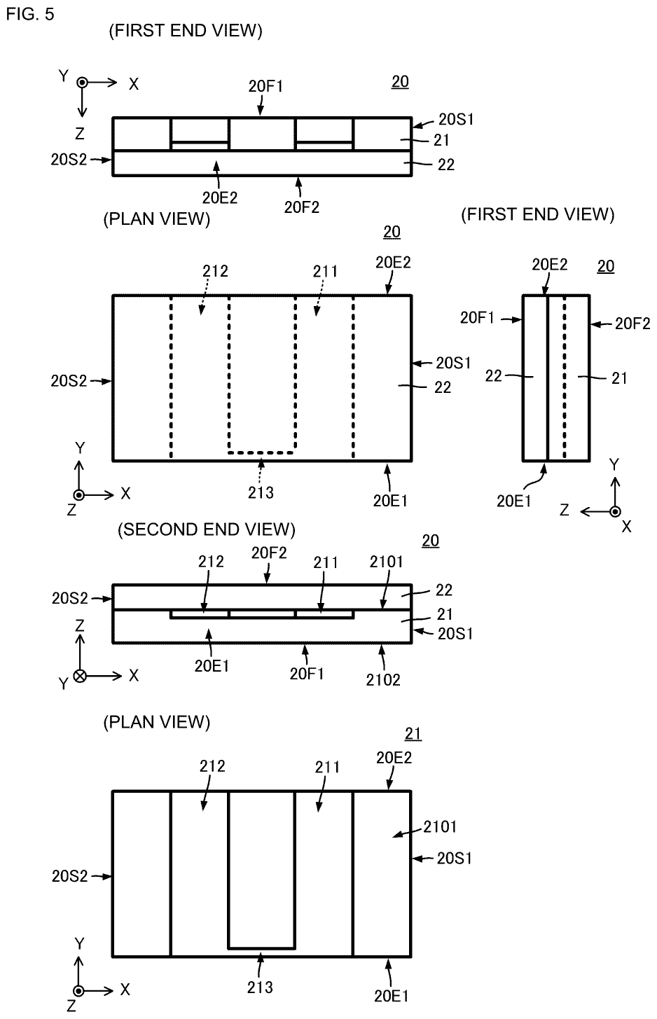

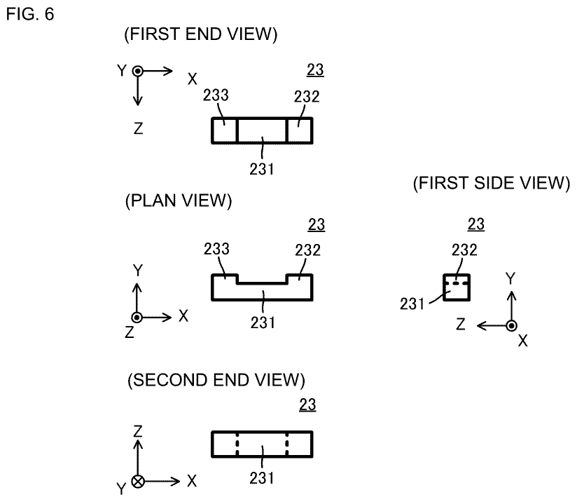

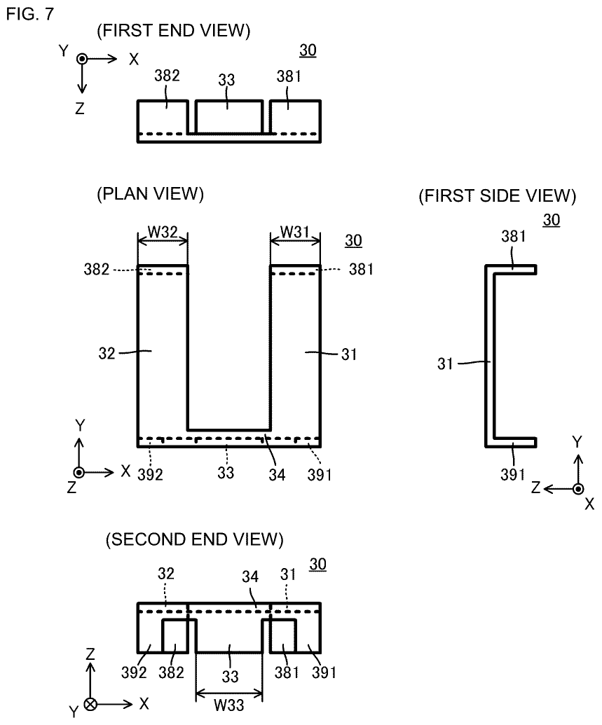

FIGS. 2A and 2B are external perspective views of the composite power inductor according to the first embodiment of the present disclosure. FIG. 3 is an exploded perspective view of the composite power inductor according to the first embodiment of the present disclosure. FIG. 4 includes four orthogonal views of the composite power inductor according to the first embodiment of the present disclosure. FIG. 4 illustrates a plan view (a view of a surface on the opposite side from a mounting surface), a first end view, a second end view, and a first side view. FIG. 5 includes four orthogonal views (a plan view, a first end view, a second end view, and a first side view) of a magnetic body obtained by combining a first magnetic body and a second magnetic body and a plan view of the first magnetic body according to the first embodiment of the present disclosure. FIG. 6 includes four orthogonal views (a plan view, a first end view, a second end view, and a first side view) of a third magnetic body according to the first embodiment of the present disclosure. FIG. 7 includes four orthogonal views (a plan view, a first end view, a second end view, and a first side view) of a conductor member according to the first embodiment of the present disclosure. Although the three orthogonal axes are respectively denoted as the X axis, Y axis, and Z axis in each drawing, these names of the axes are used for ease of description. These names of the axes do not limit, for example, the direction or the like of disposition of the composite power inductor 10 on a circuit board.

As illustrated in FIGS. 2A, 2B, 3, and 4, the composite power inductor 10 includes a magnetic body 21, a magnetic body 22, a magnetic body 23, and a conductor member 30. The magnetic body 21 corresponds to a first magnetic member, the magnetic body 22 corresponds to a second magnetic member, and the magnetic body 23 corresponds to a third magnetic member.

### (Magnetic Bodies)

As illustrated in FIG. 5, the magnetic body 21 and the magnetic body 22 are flat plates.

The magnetic body 21 includes a main flat surface 2101, a main flat surface 2102, an end surface 20E1, an end surface 20E2, a side surface 20S1, and a side surface 20S2. The main flat surface 2101 and the main flat surface 2102 face each other and are orthogonal to the Z-axis direction (a thickness direction of the magnetic body 21). The end surface 20E1 and the end surface 20E2 face each other, are parallel to the X-axis direction (a long side direction of the magnetic body 21 according to the present embodiment), and are orthogonal to the Y-axis direction (a short side direction of the magnetic body 21 according to the present embodiment). The end surface 20E1 and the end surface 20E2 correspond to end surfaces of the magnetic body 20 obtained by superposing the magnetic body 21 and the magnetic body 22 on each other. The side surface 20S1 and the side surface 20S2 face each other, are parallel to the Y-axis direction, and are orthogonal to the X-axis direction. The side surface 20S1 and the side surface 20S2 correspond to end surfaces of the magnetic body 20 obtained by superposing the magnetic body 21 and the magnetic body 22 on each other.

The magnetic body 21 has a groove 211 and a groove 212. The groove 211 and the groove 212 are recessed from the main flat surface 2101. The groove 211 and the groove 212 extend parallel to the Y-axis direction of the magnetic body 21, reach the end surface 20E1 and the end surface 20E2, and are open to the outside of the magnetic body 21. In the X-axis direction, the distance between the groove 211 and the groove 212 (the width of an inner leg portion 10ZI (see FIG. 2A) of the composite power inductor 10) is greater than the distance between the groove 211 and the side surface 20S1 (the width of an outer leg portion 10ZO1 (see FIG. 2A) of the composite power inductor 10) and the distance between the groove 212 and the side surface 20S2 (the width of an outer leg portion 10ZO2 (see FIG. 2A) of the composite power inductor 10).

The groove 211 and the groove 212 are spaced from each other in the X-axis direction of the magnetic body 21. The depth of the groove 211 and the groove 212 is substantially the same as the height (thickness) of an inductor conductor 31 and an inductor conductor 32 of the conductor member 30.

The magnetic body 21 has a groove 213. The groove 213 extends in the X-axis direction and communicates with an end portion of the groove 211 and an end portion of the groove 212 on the end surface 20E2 side. The groove 213 are open to the outside of the magnetic body 21 at the end surface 20E2 of the magnetic body 21.

The magnetic body 22 abuts on the main flat surface 2101 of the magnetic body 21. Thus, the magnetic body 20 having a substantially box shape in which the magnetic body 21 and the magnetic body 22 are laminated is formed.

As illustrated in FIG. 6, the magnetic body 23 includes a main body 231, a protrusion 232, and a protrusion 233. The main body 231 has a box shape extending in the X-axis direction. The protrusion 232 is formed at one end of the main body 231 in the extending direction of the main body 231 and protrudes from the main body 231 in the Y-axis direction. The protrusion 233 is formed at another end of the main body 231 in the extending direction of the main body 231 and protrudes from the main body 231 in the Y-axis direction (the same direction of the protrusion 232).

The magnetic body 23 is disposed and secured to the magnetic body 21 such that a distal end surface of the protrusion 232 and a distal end surface of the protrusion 233 abut on the end surface 20E2 of the magnetic body 21.

### (Conductor Member)

As illustrated in FIG. 7, the conductor member 30 includes the inductor conductor 31, the inductor conductor 32, an inductor conductor 33, a connection conductor 34, a terminal conductor 381, a terminal conductor 382, a terminal conductor 391, and a terminal conductor 392. The inductor conductor 31, the inductor conductor 32, the inductor conductor 33, the connection conductor 34, the terminal conductor 381, the terminal conductor 382, the terminal conductor 391, and the terminal conductor 392 are formed by, for example, processing such as pressing a single conductor plate having a predetermined thickness. The term “same” in the present embodiment includes deviations within the acceptable range of manufacturing error.

The inductor conductor 31 and the inductor conductor 32 are plate-shaped linear conductors. A width W31 of the inductor conductor 31 and a width W32 of the inductor conductor 32 are the same. The width W31 of the inductor conductor 31 and the width W32 of the inductor conductor 32 are the same as the width of the groove 211 and the width of the groove 212 in the magnetic body 21.

The length of the inductor conductor 31 and the length of the inductor conductor 32 are the same. The length of the inductor conductor 31 and the length of the inductor conductor 32 are the same as the distance between the end surface 20E1 and the end surface 20E2 in the magnetic body 21.

The inductor conductor 31 and the inductor conductor 32 extend in the Y-axis direction and are disposed so as to be spaced apart from each other in the X-axis direction. That is, the inductor conductor 31 and the inductor conductor 32 are arranged parallel to each other. The spacing between the inductor conductor 31 and the inductor conductor 32 is the same as the spacing between the groove 211 and the width of the groove 212 in the magnetic body 21.

The terminal conductor 381 is a plate-shaped conductor extending in the Z-axis direction. The terminal conductor 381 is connected to one end of the inductor conductor 31 in the extending direction of the inductor conductor 31. The terminal conductor 382 is a plate-shaped conductor extending in the Z-axis direction. The terminal conductor 382 is connected to one end of the inductor conductor 32 in the extending direction of the inductor conductor 32.

The connection conductor 34 is a conductor extending in the X-axis direction. The connection conductor 34 is connected to another end of the inductor conductor 31 in the extending direction of the inductor conductor 31 and another end of the inductor conductor 32 in the extending direction of the inductor conductor 32.

The inductor conductor 33 is a plate-shaped conductor extending in the Z-axis direction. That is, the extending direction of the inductor conductor 33 is orthogonal to the extending direction of the inductor conductor 31 and the inductor conductor 32.

In the X-axis direction, the inductor conductor 33 is disposed between the inductor conductor 31 and the inductor conductor 32. In the Y-axis direction, the inductor conductor 33 is disposed at substantially the same position as those of the other end of the inductor conductor 31 and the other end of the inductor conductor 32 in the extending direction of the inductor conductor 31 and the inductor conductor 32. In the Z-axis direction, the inductor conductor 33 is disposed on the same side as the terminal conductor 381 and the terminal conductor 382 with reference to the inductor conductor 31 and the inductor conductor 32.

The inductor conductor 33 is connected to the other end of the inductor conductor 31 and the other end of the inductor conductor 32 through the connection conductor 34.

A width W33 of the inductor conductor 33 is greater than the width W31 of the inductor conductor 31 and the width W32 of the inductor conductor 32 (W33>W31=W32).

The terminal conductor 391 is a plate-shaped conductor extending in the Z-axis direction. The terminal conductor 391 is connected to the other end of the inductor conductor 31 in the extending direction of the inductor conductor 31. The terminal conductor 392 is a plate-shaped conductor extending in the Z-axis direction. The terminal conductor 392 is connected to the one end of the inductor conductor 32 in the extending direction of the inductor conductor 32. In the Z-axis direction, the terminal conductor 391 and the terminal conductor 392 are disposed on the same side as the inductor conductor 33, the terminal conductor 381, and the terminal conductor 382 with reference to the inductor conductor 31 and the inductor conductor 32.

### (Specific Structure of Composite Power Inductor)

As illustrated in FIGS. 2A, 2B, and 3, the conductor member 30 is disposed in the magnetic body 21 such that the inductor conductor 31 and the inductor conductor 32 are fitted in the groove 211 and the groove 212 of the magnetic body 21. The connection conductor 34 of the conductor member 30 is disposed such that at least part of the connection conductor 34 is fitted along the groove 213 of the magnetic body 21. The inductor conductor 33, the terminal conductor 391, and the terminal conductor 392 of the conductor member 30 abut on the end surface 20E2 of the magnetic body 21. The terminal conductor 381 and the terminal conductor 382 of the conductor member 30 abut on the end surface 20E1 of the magnetic body 21. The terminal conductor 391 or the terminal conductor 392 does not necessarily abut on the end surface 20E2. Likewise, the terminal conductor 381 or the terminal conductor 382 does not necessarily abut on the end surface 20E1.

A distal end portion of the terminal conductor 381 (an end portion on the opposite side from an end portion connected to the inductor conductor 31) and a distal end portion of the terminal conductor 382 (an end portion on the opposite side from an end portion connected to the inductor conductor 32) are substantially flush with the main flat surface 2102 of the magnetic body 21.

A distal end portion of the terminal conductor 391 (an end portion on the opposite side from an end portion connected to the inductor conductor 31) and a distal end portion of the terminal conductor 392 (an end portion on the opposite side from an end portion connected to the inductor conductor 32) are substantially flush with the main flat surface 2102 of the magnetic body 21.

A distal end portion of the inductor conductor 33 (an end portion on the opposite side from an end portion connected to the inductor conductor 31 and the inductor conductor 32 through the connection conductor 34) is substantially flush with the main flat surface 2102 of the magnetic body 21.

The magnetic body 23 is disposed so as to surround the inductor conductor 33. Specifically, the magnetic body 23 is secured to the end surface 20E1 of the magnetic body 21 such that the inductor conductor 33 is fitted in a space between the protrusion 232 and the protrusion 233.

With such a structure, the inductor conductor 31 and the inductor conductor 32 are surrounded by the laminate of the magnetic body 21 and the magnetic body 22. The inductor conductor 31 is interposed between the inner leg portion 10ZI and the outer leg portion 10ZO1. The inductor conductor 32 is interposed between the inner leg portion 10ZI and the outer leg portion 10ZO2.

Furthermore, the inductor conductor 33 is surrounded by the magnetic body 21 and the magnetic body 23.

(Relationship in Connection between Composite Power Inductor 10 and Other Circuit Elements of Switching Power Source Device 80)

The distal end portion of the terminal conductor 381 is connected to the node of the switching element Q81H and the switching element Q81L of the power semiconductor IC 81. The terminal conductor 381 is the first input terminal P101 of the composite power inductor 10 in terms of the equivalent circuit. The inductor conductor 31 is the inductor 11 of the composite power inductor 10 in terms of the equivalent circuit and corresponds to a first inductor conductor of the present disclosure.

The distal end portion of the terminal conductor 382 is connected to the node of the switching element Q82H and the switching element Q82L of the power semiconductor IC 82. The distal end portion of the terminal conductor 382 is the second input terminal P102 of the composite power inductor 10 in terms of the equivalent circuit. The inductor conductor 32 is the inductor 12 of the composite power inductor 10 in terms of the equivalent circuit and corresponds to a second inductor conductor of the present disclosure.

The distal end portion of the inductor conductor 33 is connected to the Hi-side output terminal of the switching power source device 80 and one terminal of the capacitor 883. The distal end portion of the inductor conductor 33 is the output terminal P103 of the composite power inductor 10 in terms of the equivalent circuit. The inductor conductor 33 is the inductor 13 of the composite power inductor 10 in terms of the equivalent circuit and corresponds to a third inductor conductor of the present disclosure.

The distal end portion of the terminal conductor 391 is connected to the one terminal of the capacitor 881. The distal end portion of the terminal conductor 391 is the first capacitor terminal P191 of the composite power inductor 10 in terms of the equivalent circuit, and the terminal conductor 391 corresponds to a first capacitor terminal conductor of the present disclosure.

The distal end portion of the terminal conductor 392 is connected to the one terminal of the capacitor 882. The distal end portion of the terminal conductor 392 is the second capacitor terminal P192 of the composite power inductor 10 in terms of the equivalent circuit, and the terminal conductor 392 corresponds to a second capacitor terminal conductor of the present disclosure.

### (Current and Magnetic Field of Composite Power Inductor)

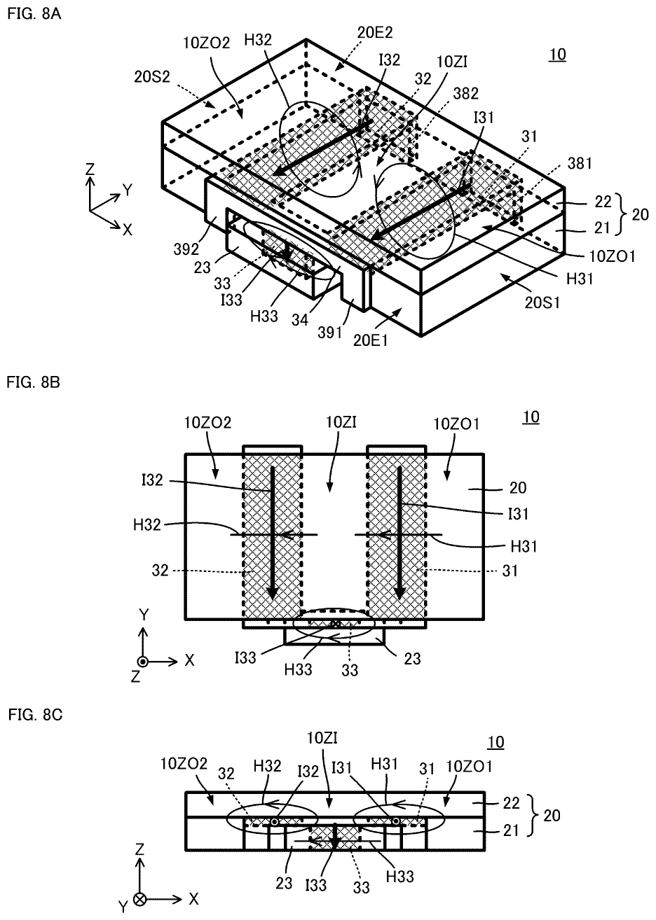

FIGS. 8A, 8B and 8C are diagrams illustrating, in a simplified manner, states of currents and magnetic fields of the composite power inductor according to the first embodiment of the present disclosure. FIG. 8A is a perspective view, FIG. 8B is a plan view, and FIG. 8C is an end view.

As illustrated in FIGS. 8A, 8B, and 8C, when the switching power source device 80 is operated, currents in the same direction flow through the inductor conductor 31 and the inductor conductor 32. Specifically, a current I31 flows through the inductor conductor 31 from the end surface 20E2 toward the end surface 20E1, and a current I32 flows through the inductor conductor 32 from the end surface 20E2 toward the end surface 20E1. The directions of the current I31 and the current I32 are the same.

As a result, in the inner leg portion 10ZI between the inductor conductor 31 and the inductor conductor 32, the direction of a magnetic field H31 generated by the current I31 of the inductor conductor 31 and the direction of a magnetic field H32 generated by the current I32 of the inductor conductor 32 are opposite to each other. Thus, a magnetic flux by the current I31 of the inductor conductor 31 and a magnetic flux by the current I32 of the inductor conductor 32 cancel each other out. This can reduce a magnetic flux density in the inner leg portion 10ZI and suppress magnetic saturation. Consequently, the distance between the inductor conductor 31 and the inductor conductor 32 can be reduced. In other words, the width of the inner leg portion 10ZI can be reduced. Accordingly, the size of the composite power inductor 10 can be reduced and degradation of the characteristics of the composite power inductor 10 can be suppressed.

The direction of the magnetic field H31 and the direction of the magnetic field H32 are the same in the outer leg portion 10ZO1, and the direction of the magnetic field H31 and the direction of the magnetic field H32 are the same in the outer leg portion 10ZO2. Thus, in the outer leg portion 10ZO1 and the outer leg portion 10ZO2, the magnetic flux by the current I31 of the inductor conductor 31 and the magnetic flux by the current I32 of the inductor conductor 32 strengthen each other. Accordingly, the characteristics of the composite power inductor 10 can be improved without an increase in the size of the composite power inductor 10.

Furthermore, as illustrated in FIGS. 8A, 8B, and 8C, when the switching power source device 80 is operated, a current I33 parallel to the laminating direction of the magnetic body 21 and the magnetic body 22 flows through the inductor conductor 33. That is, the direction of the current I33 flowing through the inductor conductor 33 is orthogonal to the direction of the current I31 flowing through the inductor conductor 31 and the direction of the current I32 flowing through the inductor conductor 32.

Thus, a plane created by a magnetic field H33 by the current I33 is orthogonal to a plane created by the magnetic field H31 by the current I31 and a plane created by the magnetic field H32 by the current I32. Accordingly, a magnetic flux by the current I33 is rarely coupled to the magnetic flux by the current I31 and the magnetic flux by the current I32. Thus, the magnetic flux density does not increase. As a result, magnetic saturation of the inductor conductor 33 is suppressed, and the output filter circuit including the inductor conductor 33 (inductor 13) can realized desired filter characteristics without increasing the shape of the composite power inductor 10.

As described above, with the configuration of the present embodiment, the composite power inductor 10 can be realized in a physically small shape, and the desired characteristics of the composite power inductor 10 and the switching power source device 80 can be realized. Furthermore, the composite power inductor 10 realizes the inductors of a plurality of power conversion circuits and the inductor of the output filter circuit in a single housing. Thus, the number of components can be reduced compared to the related-art configuration separately including the inductors of a plurality of power conversion circuits and the inductor of the output filter circuit. That is, the functions to be realized by a plurality of power inductors can be obtained by a single integrated composite power inductor, the magnetic saturation of the magnetic body can be suppressed by cancelling out the magnetic fluxes generated by direct-current output currents, and ripples of an output voltage can be reduced by including a low-pass filter against the output current.

Furthermore, in the configuration of the present embodiment, the inductor conductor 31 and the inductor conductor 32 are surrounded by the laminate of the magnetic body 21 and the magnetic body 22. Thus, inductance of the inductor 11 by the inductor conductor 31 and inductance of the inductor 12 by the inductor conductor 32 can be increased without changing the shape. Furthermore, the magnetic flux by the current I31 of the inductor conductor 31 and the magnetic flux by the inductor conductor 32 are concentrated in the laminate of the magnetic body 21 and the magnetic body 22 and unlikely to leak to the outside. Accordingly, the composite power inductor 10 can realize a small shape and suppress influence to the outside.

Likewise, the inductor conductor 33 is surrounded by the magnetic body 21 and the magnetic body 23. Thus, inductance of the inductor 13 by the inductor conductor 33 can be increased without changing the shape. Furthermore, the magnetic flux by the current I33 of the inductor conductor 33 is concentrated in a structure of the magnetic body 21 and the magnetic body 23 and unlikely to leak to the outside. Accordingly, the composite power inductor 10 can realize a small shape, suppress coupling of the magnetic flux of the inductor conductor 33 to the terminal conductor 391 and the terminal conductor 392, and suppress the influence to the outside.

Furthermore, in the composite power inductor 10, the width W33 of the inductor conductor 33 is greater than the width W31 of the inductor conductor 31 and the width W32 of the inductor conductor 32. The current I33 of the inductor conductor 33 is a resultant current of the current I31 of the inductor conductor 31 and the current I32 of the inductor conductor 32 and larger than the current I31 and the current I32.

However, since the width W33 of the inductor conductor 33 is great, resistance to the current I33 can be reduced even when the current I33 is great. Thus, the composite power inductor 10 can suppress transmission loss and heat loss in the inductor conductor 33.

The length of the inductor conductor 33 is smaller than the length of the inductor conductor 31 and the length of the inductor conductor 32. Thus, resistance to the current I33 can be reduced even when the current I33 is great. Accordingly, the composite power inductor 10 can suppress transmission loss and heat loss in the inductor conductor 33.

### (Structural Example of Switching Power Source Device)

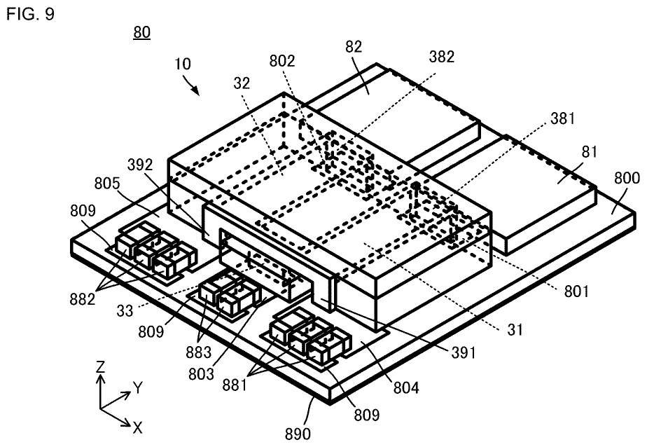

FIG. 9 is a perspective view illustrating an example of the switching power source device according to the first embodiment of the present disclosure. As illustrated in FIG. 9, the switching power source device 80 includes a circuit board 800, the composite power inductor 10, the power semiconductor IC 81, the power semiconductor IC 82, a plurality of capacitors 881, a plurality of capacitors 882, and a plurality of capacitors 883. The composite power inductor 10, the power semiconductor IC 81, the power semiconductor IC 82, the plurality of capacitors 881, the plurality of capacitors 882, and the plurality of capacitors 883 are mounting type electronic components.

The circuit board 800 has a component mounting surface and a ground surface. Connection conductor patterns 801 to 805 are formed on the component mounting surface. Each of the connection conductor patterns 801 to 805 has a film shape. A plurality of ground conductor patterns 809 are formed on the component mounting surface. Each of the ground conductor patterns 809 has a film shape. A ground conductor pattern 890 is formed on the ground surface. The ground conductor pattern 890 is formed at a position superposed on at least a plurality of the ground conductor patterns 809 in plan view of the circuit board 800. For example, the ground conductor pattern 890 is formed on the entirety of the ground surface.

The power semiconductor IC 81 and the power semiconductor IC 82 are disposed by the end surface 20E2 side of the composite power inductor 10. The power semiconductor IC 81 and the power semiconductor IC 82 are disposed along the end surface 20E2. The power semiconductor IC 81 is disposed at a position close to the terminal conductor 381 of the composite power inductor 10. The power semiconductor IC 82 is disposed at a position close to the terminal conductor 382 of the composite power inductor 10.

The power semiconductor IC 81 and the terminal conductor 381 are mounted on the connection conductor pattern 801 and electrically physically connected to the connection conductor pattern 801. The power semiconductor IC 82 and the terminal conductor 382 are mounted on the connection conductor pattern 802 and electrically physically connected to the connection conductor pattern 802.

The plurality of capacitors 881, the plurality of capacitors 882, and the plurality of capacitors 883 are disposed by the end surface 20E1 side of the composite power inductor 10. The plurality of capacitors 881 are disposed at positions close to the terminal conductor 391 of the composite power inductor 10. The plurality of capacitors 882 are disposed at positions close to the terminal conductor 392 of the composite power inductor 10. The plurality of capacitors 883 are disposed at positions close to the inductor conductor 33 of the composite power inductor 10.

The inductor conductor 33 and the plurality of capacitors 883 are mounted on the connection conductor pattern 803 and electrically physically connected to the connection conductor pattern 803. The terminal conductor 391 and the plurality of capacitors 881 are mounted on the connection conductor pattern 804 and electrically physically connected to the connection conductor pattern 804. The terminal conductor 392 and the plurality of capacitors 882 are mounted on the connection conductor pattern 805 and electrically physically connected to the connection conductor pattern 805.

The plurality of capacitors 881 are mounted on a ground conductor pattern 809 and electrically connected to the reference potential, the plurality of capacitors 882 are mounted on a ground conductor pattern 809 and electrically connected to the reference potential, and the plurality of capacitors 883 are mounted on a ground conductor pattern 809 and electrically connected to the reference potential.

With such a configuration, the shape of the switching power source device 80 becomes more space-saving.

### Second Embodiment

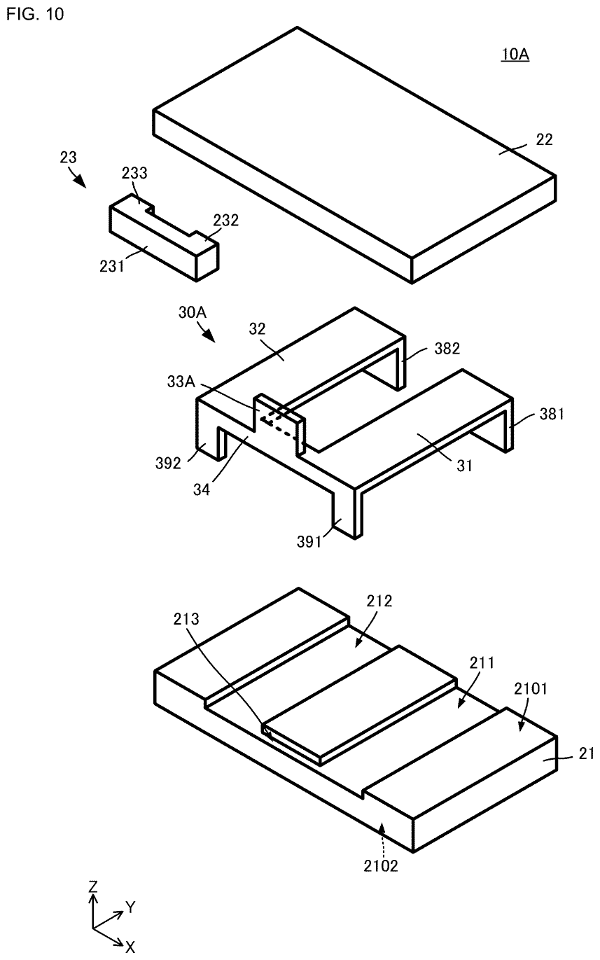

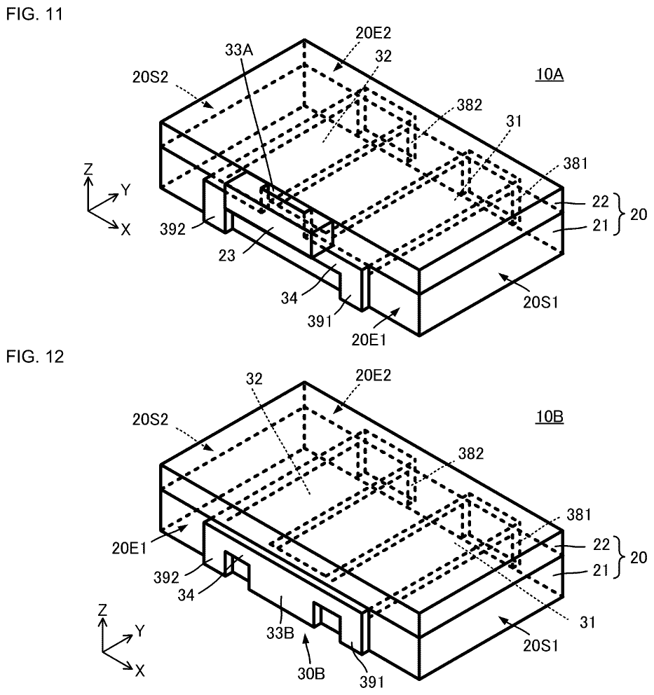

A composite power inductor according to a second embodiment of the present disclosure will be described with reference to the drawings. FIG. 10 is an exploded perspective view of the composite power inductor according to the second embodiment of the present disclosure. FIG. 11 is an external perspective view of the composite power inductor according to the second embodiment of the present disclosure.

As illustrated in FIGS. 10 and 11, a composite power inductor 10A according to the second embodiment has a structure of a conductor member 30A and a form of disposition of the magnetic body 23 that are different from those of the composite power inductor 10 according to the first embodiment. The configuration of the composite power inductor 10A other than the above description is similar to or the same as that of the composite power inductor 10, and the description of the similar or the same portions is omitted.

The conductor member 30A includes an inductor conductor 33A. In the Z-axis direction, the inductor conductor 33A is disposed on the opposite side from the terminal conductor 391 and the terminal conductor 392 with reference to the inductor conductor 31 and the inductor conductor 32. Thus, the inductor conductor 33A abuts on the end surface of the magnetic body 22.

The magnetic body 23 is secured to the end surface of the magnetic body 22 so as to surround the inductor conductor 33A.

With such a configuration, as is the case with the composite power inductor 10 according to the first embodiment, the composite power inductor 10A can be realized in a physically small shape, and the desired characteristics of the composite power inductor 10A can be realized.

With this configuration, the inductor conductor 33A is not interposed between the terminal conductor 391 and the terminal conductor 392. This allows an increase in the width of the inductor conductor 33A. Thus, the composite power inductor 10A can suppress various losses caused by the current.

In this configuration, the length of the inductor conductor 33A is not necessarily the same as the length of the terminal conductor 391 and the terminal conductor 392. Thus, the composite power inductor 10A allows adjustment of the inductance of the inductor conductor 33A and adjustment of the filter characteristics of the output filter circuit.

### Third Embodiment

A composite power inductor according to a third embodiment of the present disclosure will be described with reference to the drawings. FIG. 12 is an external perspective view of the composite power inductor according to the third embodiment of the present disclosure.

As illustrated in FIG. 12, a composite power inductor 10B according to the third embodiment is different from the composite power inductor 10 according to the first embodiment in that the magnetic body 23 is omitted from the composite power inductor 10B. The configuration of the composite power inductor 10B other than the above description is similar to or the same as that of the composite power inductor 10, and the description of the similar or the same portions is omitted.

The conductor member 30B of the composite power inductor 10B includes an inductor conductor 33B. The inductor conductor 33B abuts on the end surface 20E1 of the magnetic body 21 and is exposed to the outside except for the surface thereof abutting on the end surface 20E1. With such a configuration, the inductance of the inductor 13 by the inductor conductor 33B can be reduced. Thus, the composite power inductor 10B allows adjustment of the filter characteristics of the output filter circuit.

With this configuration, a space for insertion of the magnetic body is not required between inductor conductor 33B and the terminal conductor 391. Likewise, with this configuration, a space for insertion of the magnetic body is not required between inductor conductor 33B and the terminal conductor 391. Thus, the width of the inductor conductor 33B can be increased, and the composite power inductor 10B can suppress various losses caused by the current.

### Fourth Embodiment

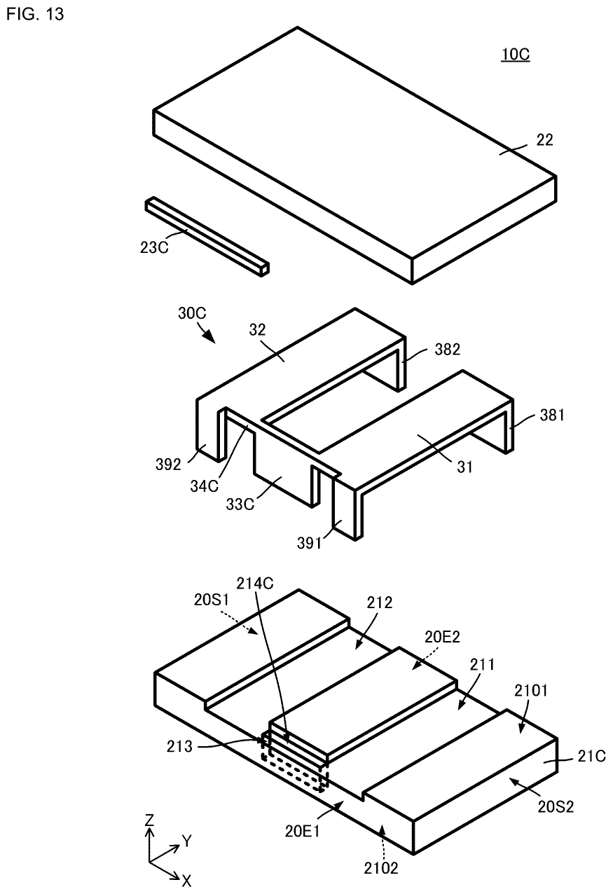

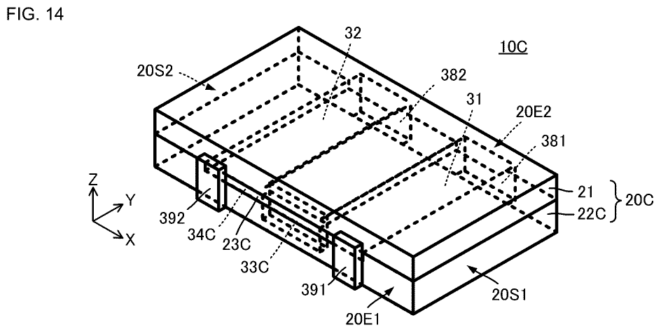

A composite power inductor according to a fourth embodiment of the present disclosure will be described with reference to the drawings. FIG. 13 is an exploded perspective view of the composite power inductor according to the fourth embodiment of the present disclosure. FIG. 14 is an external perspective view of the composite power inductor according to the fourth embodiment of the present disclosure.

As illustrated in FIGS. 13 and 14, a composite power inductor 10C according to the fourth embodiment is different from the composite power inductor 10 according to the first embodiment in a magnetic body 21C, magnetic body 23C, and a conductor member 30C. The configuration of the composite power inductor 10C other than the above description is similar to or the same as that of the composite power inductor 10, and the description of the similar or the same portions is omitted.

The composite power inductor 10C includes the magnetic body 21C, the magnetic body 23C, and the conductor member 30C.

The magnetic body 21C is different from the magnetic body 21 according to the first embodiment in that the magnetic body 21C has a through hole 214C. The through hole 214C is formed along the groove 213 and has a box-shaped inner space. The through hole 214C is formed at a position farther from the end surface 20E1 than the groove 213 (the position on the end surface 20E2 side). The through hole 214C extends through a space between bottom surfaces of the grooves 213, 211, and 212 and the main flat surface 2102 of the magnetic body 21C. In other words, the through hole 214C extends through the magnetic body 21C in the thickness direction (Z-axis direction).

The conductor member 30C includes an inductor conductor 33C and a connection conductor 34C. The inductor conductor 33C is disposed at a position offset to the one end side from the other ends (ends on the sides respectively connected to the terminal conductor 391 and the terminal conductor 392) in the inductor conductor 31 and the inductor conductor 32. The inductor conductor 33C is connected to the inductor conductor 31 and the inductor conductor 32 through the connection conductor 34C.

The conductor member 30C is disposed in the magnetic body 21C such that the inductor conductor 31 is fitted in the groove 211, the inductor conductor 32 is fitted in the groove 212, and the inductor conductor 33C is inserted through the through hole 214C.

The magnetic body 23C has a box shape. The magnetic body 23C is fitted into the groove 213.

With such a configuration, regarding the composite power inductor 10C, the inductor conductor 31, the inductor conductor 32, and the inductor conductor 33C are disposed in the laminate of the magnetic body 21C and the magnetic body 22. Thus, even when a portion such as the magnetic body 23 of the composite power inductor 10 externally protruding from the laminate of the magnetic body 21 and the magnetic body 22 is not provided, the composite power inductor 10C can realize the characteristics equivalent to those of the composite power inductor 10. Accordingly, although the composite power inductor 10C is smaller in size than the composite power inductor 10, the composite power inductor 10C can produce function effects similar to or the same as those of the composite power inductor 10.

The configurations of the above-described embodiments can be combined with each other as appropriate, and the function effects corresponding to the combinations can be produced.

<1> A switching power source device equipped with a composite power inductor. The device includes a first inductor conductor having a linear shape, a second inductor conductor having a linear shape, a third inductor conductor, and a single magnetic body configured to form magnetic paths of magnetic fluxes generated by currents flowing through the first inductor conductor, the second inductor conductor, and the third inductor conductor. One end of the first inductor conductor is connected to a first input terminal, and another end of the first inductor conductor is connected to one end of the third inductor conductor. One end of the second inductor conductor is connected to a second input terminal, and another end of the second inductor conductor is connected to the one end of the third inductor conductor. The first inductor conductor, the second inductor conductor, and the third inductor conductor are interposed by or contained in the magnetic body. The first inductor conductor and the second inductor conductor are arranged parallel to each other to cause a magnetic flux generated by a current flowing through the first inductor conductor and a magnetic flux generated by a current flowing through the second inductor conductor to cancel out each other in an inner leg portion between the first inductor conductor and the second inductor conductor in the magnetic body and to cause the magnetic flux generated by the current flowing through the first inductor conductor and the magnetic flux generated by the current flowing through the second inductor conductor to strengthen each other in outer leg portions further to outer sides than the first inductor conductor and the second inductor conductor in the magnetic body. The third inductor conductor is disposed such that a plane created by a magnetic flux generated by a current flowing through the third inductor conductor is orthogonal to a plane created by the magnetic flux generated by the current flowing through the first inductor conductor and a plane created by the magnetic flux generated by the current flowing through the second inductor conductor. The first inductor conductor and the second inductor conductor form power conversion circuits. The third inductor conductor forms a low-pass filter for an output current of the power conversion circuits.

<2> In the switching power source device equipped with a composite power inductor according to <1>, the magnetic body includes a first magnetic member and a second magnetic member that have respective portions superposed on each other, and a part of the first inductor conductor and a part of the second inductor conductor are interposed between or contained in the first magnetic member and the second magnetic member.

<3> In the switching power source device equipped with a composite power inductor according to <1> or <2>, the first magnetic member has a through hole, and at least part of the third inductor conductor extends through the through hole.

<4> In the switching power source device equipped with a composite power inductor according to <1> or <2>, the magnetic body includes a third magnetic member that has a portion superposed on at least one of the first magnetic member and the second magnetic member, and at least part of the third inductor conductor is surrounded by the first magnetic member and the third magnetic member or by the second magnetic member and the third magnetic member.

<5> In the switching power source device equipped with a composite power inductor according to any one of <1> to <4>, a length of the first inductor conductor and a length of the second inductor conductor are greater than a length of the third inductor conductor.

<6> In the switching power source device equipped with a composite power inductor according to any one of <1> to <5>, a width of at least part of the third inductor conductor is greater than a width of the first inductor conductor and a width of the second inductor conductor.

<7> The switching power source device equipped with a composite power inductor according to any one of <1> to <6> further includes a first capacitor terminal conductor connected to the other end of the first inductor conductor and the one end of the third inductor conductor, and a second capacitor terminal conductor connected to the other end of the second inductor conductor and the one end of the third inductor conductor.

<8> In the switching power source device equipped with a composite power inductor according to <7>, the magnetic body includes a main flat surface, and a first end surface and a second end surface that are orthogonal to the main flat surface and that face each other. The first inductor conductor and the second inductor conductor are disposed along the main flat surface. The third inductor conductor, the first capacitor terminal conductor, and the second capacitor terminal conductor are disposed along the first end surface.

<9> The switching power source device equipped with a composite power inductor according to <8> further includes a circuit board on which the composite power inductor is mounted and which has a ground conductor pattern, and a first capacitor element, a second capacitor element, and a third capacitor element which are mounted on the circuit board. The first capacitor element is connected between the first capacitor terminal conductor and the ground conductor pattern. The second capacitor element is connected between the second capacitor terminal conductor and the ground conductor pattern. The third capacitor element is connected between another end of the third inductor conductor and the ground conductor pattern.

<10> The switching power source device equipped with a composite power inductor according to any one of <1> to <9> further includes a first power conversion circuit including a first inductor using the first inductor conductor, a second power conversion circuit including a second inductor using the second inductor conductor, and an output filter circuit including a third inductor using the third inductor conductor.

What is claimed is:

1. A switching power source device equipped with a composite power inductor, the device comprising:
a first inductor conductor having a linear shape;
a second inductor conductor having a linear shape;
a third inductor conductor; and
a single magnetic body configured to define magnetic paths of magnetic fluxes generated by currents flowing through the first inductor conductor, the second inductor conductor, and the third inductor conductor,
wherein
one end of the first inductor conductor is connected to a first input terminal, and another end of the first inductor conductor is connected to one end of the third inductor conductor,
one end of the second inductor conductor is connected to a second input terminal, and another end of the second inductor conductor is connected to the one end of the third inductor conductor,
the first inductor conductor, the second inductor conductor, and the third inductor conductor are interposed by or included in the magnetic body,
the first inductor conductor and the second inductor conductor are parallel to each other to cause
a magnetic flux generated by a current flowing through the first inductor conductor and a magnetic flux generated by a current flowing through the second inductor conductor to cancel out each other in an inner leg portion between the first inductor conductor and the second inductor conductor in the magnetic body, and
the magnetic flux generated by the current flowing through the first inductor conductor and the magnetic flux generated by the current flowing through the second inductor conductor to strengthen each other in outer leg portions further to outer sides than the first inductor conductor and the second inductor conductor in the magnetic body,
the third inductor conductor is configured such that a plane created by a magnetic flux generated by a current flowing through the third inductor conductor is orthogonal to a plane created by the magnetic flux generated by the current flowing through the first inductor conductor and a plane created by the magnetic flux generated by the current flowing through the second inductor conductor,
the first inductor conductor and the second inductor conductor configure power conversion circuits, and
the third inductor conductor configures a low-pass filter for an output current of the power conversion circuits.

2. The device according to claim 1, wherein
the magnetic body includes a first magnetic member and a second magnetic member that have respective portions superposed on each other, and
a part of the first inductor conductor and a part of the second inductor conductor are interposed between or included in the first magnetic member and the second magnetic member.

3. The device according to claim 1, wherein
the magnetic body includes a first magnetic member that has a through hole, and
at least part of the third inductor conductor extends through the through hole.

4. The device according to claim 1, wherein
the magnetic body includes a first magnetic member, a second magnetic member and a third magnetic member, the third magnetic member having a portion superposed on at least one of the first magnetic member and the second magnetic member, and
at least part of the third inductor conductor is surrounded by the first magnetic member and the third magnetic member or by the second magnetic member and the third magnetic member.

5. The device according to claim 1, wherein
a length of the first inductor conductor and a length of the second inductor conductor are greater than a length of the third inductor conductor.

6. The device according to claim 1, wherein
a width of at least part of the third inductor conductor is greater than a width of the first inductor conductor and a width of the second inductor conductor.

7. The device according to claim 1, further comprising:
a first capacitor terminal conductor connected to the other end of the first inductor conductor and the one end of the third inductor conductor; and
a second capacitor terminal conductor connected to the other end of the second inductor conductor and the one end of the third inductor conductor.

8. The device according to claim 7, wherein
the magnetic body includes
a main flat surface, and
a first end surface and a second end surface that are orthogonal to the main flat surface and that face each other,
the first inductor conductor and the second inductor conductor are disposed along the main flat surface, and
the third inductor conductor, the first capacitor terminal conductor, and the second capacitor terminal conductor are disposed along the first end surface.

9. The device according to claim 8, further comprising:
a circuit board on which the composite power inductor is mounted and which has a ground conductor pattern; and
a first capacitor element, a second capacitor element, and a third capacitor element which are mounted on the circuit board,
wherein
the first capacitor element is connected between the first capacitor terminal conductor and the ground conductor pattern,
the second capacitor element is connected between the second capacitor terminal conductor and the ground conductor pattern, and
the third capacitor element is connected between another end of the third inductor conductor and the ground conductor pattern.

10. The device according to claim 1, further comprising:
a first power conversion circuit including a first inductor using the first inductor conductor;
a second power conversion circuit including a second inductor using the second inductor conductor; and
an output filter circuit including a third inductor using the third inductor conductor.

11. The device according to claim 2, wherein
the magnetic body includes a first magnetic member that has a through hole, and
at least part of the third inductor conductor extends through the through hole.

12. The device according to claim 2, wherein
the magnetic body includes a first magnetic member, a second magnetic member and a third magnetic member, the third magnetic member having a portion superposed on at least one of the first magnetic member and the second magnetic member, and
at least part of the third inductor conductor is surrounded by the first magnetic member and the third magnetic member or by the second magnetic member and the third magnetic member.

13. The device according to claim 2, wherein
a length of the first inductor conductor and a length of the second inductor conductor are greater than a length of the third inductor conductor.

14. The device according to claim 3, wherein
a length of the first inductor conductor and a length of the second inductor conductor are greater than a length of the third inductor conductor.

15. The device according to claim 2, wherein
a width of at least part of the third inductor conductor is greater than a width of the first inductor conductor and a width of the second inductor conductor.

16. The device according to claim 3, wherein
a width of at least part of the third inductor conductor is greater than a width of the first inductor conductor and a width of the second inductor conductor.

17. The device according to claim 2, further comprising:
a first capacitor terminal conductor connected to the other end of the first inductor conductor and the one end of the third inductor conductor; and
a second capacitor terminal conductor connected to the other end of the second inductor conductor and the one end of the third inductor conductor.

18. The device according to claim 3, further comprising:
a first capacitor terminal conductor connected to the other end of the first inductor conductor and the one end of the third inductor conductor; and
a second capacitor terminal conductor connected to the other end of the second inductor conductor and the one end of the third inductor conductor.

19. The device according to claim 2, further comprising:
a first power conversion circuit including a first inductor using the first inductor conductor;
a second power conversion circuit including a second inductor using the second inductor conductor; and
an output filter circuit including a third inductor using the third inductor conductor.

20. The device according to claim 3, further comprising:
a first power conversion circuit including a first inductor using the first inductor conductor;
a second power conversion circuit including a second inductor using the second inductor conductor; and
an output filter circuit including a third inductor using the third inductor conductor.
